(19) United States
(12) Patent Application Publication
(10) Pub. No.: US 2022/0086640 A1
(43) Pub. Date: Mar. 17, 2022

(54) SYSTEM FOR PROVIDING A WIRELESS NETWORK

(71) Applicant: Osram GmbH, Munich (DE)

(72) Inventors: Holger SACHER, Augsburg (DE); Markus JUNG, Feldkirchen (DE); Michael ESCHEY, Wehringen (DE); Herbert ERNST, Weilheim (DE)

(21) Appl. No.: 17/422,209

(22) PCT Filed: Dec. 13, 2019
(86) PCT No.: PCT/EP2019/085154

§ 371 Date: Jul. 12, 2021

(30) Foreign Application Priority Data
Jan. 15, 2019 (DE) 10 2019 200 409.1

(51) Int. Cl. H04W 12/08; H04L 29/06; H04W 12/64; H04W 48/04

(52) U.S. Cl. CPC H04W 12/08; H04L 63/0209; H04L 63/101; H04W 84/12; H04W 12/64; H04W 48/04; H04L 63/107

(57) ABSTRACT

A system for providing a wireless network may include a plurality of wireless access points for a delimited spatial area in a building or physical structure. At least one spatial zone controller may be connected to at least some of the wireless access points and is configured to receive, via the wireless access points connected to the controller, device information regarding a terminal logging into the network and/or regarding an external wireless access point, and to determine the spatial position of the terminal and/or of the external wireless access point or the physical structure. In addition, a central security controller may be connected to the spatial zone controller to provide an access control list. The spatial zone controller may be configured to compare the received device information and the determined spatial position with the access control list.

### CROSS-REFERENCE TO RELATED APPLICATIONS

The present application is a national stage entry according to 35 U.S.C. § 371 of PCT Application No. PCT/EP2019/085154 filed on Dec. 13, 2019; which claims priority to German Patent Application Serial No. 10 2019 200 409.1 filed on Jan. 15, 2019; all of which are incorporated herein by reference in their entirety and for all purposes.

### TECHNICAL FIELD

The present invention relates to a system for providing a wireless network which comprises a plurality of wireless access points, each of which can provide access to the wireless network for a delimited spatial region in a building or in a physical structure.

### BACKGROUND

Such multi-room or multi-floor wireless networks (WLAN, wireless local area network) usually go beyond the scope of customary home networks. If such wireless networks are correspondingly operated in the so-called infrastructure mode, then central routers generally establish a link to further networks, network segments or the Internet, wherein the wireless access points (AP) (also called base station in German) of the network can be connected to the router in a wired manner, e.g. via Ethernet, or themselves in a wireless manner too. In the latter case, however, the wireless access points function as wireless bridges (point-to-point) or wireless repeaters (point-to-multipoint) rather than as an actual base station. In small home networks, the router itself can include the wireless access point.

The wireless access points each supply a spatial region corresponding to their range with radiofrequency radiation in the frequency intervals of e.g. 2400 to 2483.5 GHz, of 5150 to 5350 or 5470 to 5725 GHz, or further intervals between 1 and 7 GHz or around 60 GHz, which are currently still in discussion. They transmit so-called beacons with this RF radiation in short temporal intervals, said beacons including information regarding the network name (SSID: service set identifier, or in the infrastructure network the so-called ESSID: extended service set identifier), the supported transmission rates and the type of encryption of the data to be transmitted.

In order that a building having e.g. multiple rooms and/or floors or else a physical structure such as, for instance, a company or university or research campus or a trade fair having a plurality of buildings/halls and/or an outside area having pavilions or the like, as in the case of an airport or railroad station, is supplied with a wireless network that covers the corresponding spatial region, said wireless network can be operated in an extended service set mode, in which—as described in the introduction—the individual wireless access points are connected to one another e.g. via Ethernet and span a common radio network with common network names (ESSID). Networks with large range and satisfactory spatial coverage can be obtained as a result.

Terminals (clients) with e.g. an internally provided or externally connected wireless adapter can log on and off in the radio network provided that they are situated in the corresponding spatial region of one of the wireless access points, and—provided that they are mobile terminals—they can be handed over between different wireless access points (roaming) when they leave the spatial region of one access point and reach that of another access point, or simply obtain a stronger signal from the latter. The corresponding functionality can be realized in the terminal and/or on the part of the access points communicating with one another.

In order to obtain an optimum coverage of buildings or physical structures and at the same time to save costs and complexity for the cabling and the number of devices, powerful wireless access points with large range are conventionally positioned therein at selected locations, which access points are each able by themselves to supply terminals with a radio network within a large spatial region. In this case, the permissible maximum values of 100 mW isotropic radiation power (EIRP) for the interval at 2.4 GHz or 200 mW, 500 mW or 1000 mW EIRP for the intervals at 5 GHz (depending on the interval and legal situation in the relevant country in Europe, America or Asia, etc.) are usually utilized.

Precisely on account of the high power level of the emitted signal that is required given the conventional coarse-meshed nature of a radio network in order that even remote niches or spatial regions can be concomitantly covered, the spatial region spanned by the range of the respective access point often extends significantly beyond the limits of the building or the physical structure—e.g. in rooms in one and the same building. A terminal that stays in this external region can acquire access to the radio network without authorization here e.g. by means of so-called “sniffing”, by said terminal intercepting and logging the radio connection between access point and (authorized) terminal over a period of time and evaluating this in order to take possession of the network key(s) (for example so-called known-plain text attacks with collection of key pairs). Just evaluating the beacons that are repeatedly transmitted only by the wireless access point may also suffice if the logged period of time is sufficiently long and the corresponding computer capacity is sufficient.

Over and above this or on the basis of this, an external wireless access point can also acquire access to the network by using corresponding information to pretend to be a regular and authorized access point of the radio network, with the result that terminals in the network erroneously log on at this access point and transmit data, which is referred to as so-called “snarfing” (so-called Janus or man-in-the-middle attacks).

Secure encryption techniques are indeed regularly available with the successor WPA2 (Wi-Fi protected access, conforming to IEEE 802,11i) to the encryption standard WEP (wired equivalent privacy) conforming to IEEE 802.11, said standard nowadays being deemed no longer to be sufficient. However, weak points of the components and misuse cannot be totally ruled out.

A further building block of the security architecture is likewise regularly an access control list, which holds device-specific information including e.g. a hardware identifier or address. The wireless access point enables network access only for the terminals which log on with this hardware address stored in the access control list. One example is the MAC address (media access control), which is uniquely assigned to every device having a network adapter (Microsoft: “physical address”, Apple: “Airport ID”, “Ethernet ID” or “Wi-Fi address”). Appropriate measures could exclude external device addresses not contained in the access control list, so-called MAC filtering.

However, every MAC address of a respective network node can easily be changed since MAC addresses are not transmitted from the network adapter of the relevant terminal to the access point, this being known as “spoofing”. Rather, in this case, either the respective operating system or a specifically configured network manager reads out this address from the adapter and transmits it to the access point. In this case, the address read out can be altered by suitable software in order to impersonate a different terminal. It should be noted that in the course of general communication at the level of the data link layer (OSI layer 2) between terminal and wireless access point such basic information (encryption type, transmission speed, MAC address, etc.) is regularly transmitted without being encrypted, and so spoofing is not made particularly difficult. Consequently, the use of MAC filters alone offers only limited protection against unauthorized network access by third parties.

### SUMMARY

It is therefore an object to propose a system for providing a wireless network which increases the security against an unauthorized access to the data transmitted in a network and improves the stability of such a radio network. It is also an object to provide a corresponding method.

The solution relates to a system for providing a wireless network which comprises a plurality of wireless access points, each of which provides access to the wireless network for a delimited spatial region in a building or in a physical structure or for the terminals (clients) situated in said spatial region. The wireless network can be an infrastructure network with a router connected in a wired manner (Ethernet, KNX, DALI, etc.) to the individual wireless access points (e.g. also a distribution system, DS), or else an ad hoc network and without further connection to other networks. Furthermore, the network is not restricted to specific technologies; by way of example, it can be a Wi-Fi network conforming to the IEEE 802.11 family, or e.g. a Zigbee network (IEEE 802.15.4).

The building or the physical structure itself is not part of the claimed solution, but rather designates the application and the spatial relation of the wireless network. A building comprises e.g. multiple rooms and/or floors. The network can be restricted to parts of buildings which are assigned e.g. to a company operating the network. As described, a physical structure can be, for instance, a company or university or research campus, or a trade fair having multiple buildings/halls and/or an outside area having pavilions or the like, but also an airport or railroad station. A characterizing factor is that zones with increased requirements in respect of network security may directly adjoin public zones or those with less stringent requirements.

Furthermore, provision is made of at least one spatial zone controller which is connected to at least one portion of the wireless access points and is designed to receive, via the wireless access points connected to said controller, device information regarding a terminal logging on in the network and/or regarding an external wireless access point, and to determine the spatial position of the relevant terminal and/or external wireless access point in or close to the building or the physical structure on the basis of an assignment to one or more of the connected wireless access points.

The expression spatial zone controller is used as an identifier for a control device connected to the wireless access points and implies that said controller is specifically configured for a spatial zone corresponding to the subset of the access points. The subset of the access points connected to the spatial zone controller therefore covers a continuous three-dimensional space (“spatial zone”) with the radiation of said subset. Said spatial zone can also extend beyond the physical limit of the building or building part (story floor, story ceiling, exterior wall, window) etc. and is determined by the range of the (outer) wireless access points.

The spatial zone controller is designed to determine the spatial position of a terminal and/or an external wireless access point in or near the building or the physical structure on the basis of an assignment to one or more of the connected wireless access points. The position determination can be effected in various ways. In the simplest case, the hardware address of that access point at which the terminal etc. logs on is compared with a position reference list (stored in a memory, for example). The position is able to be read out from said position reference list and is assigned to the terminal etc. Furthermore, a plurality of the access points which are connected to the spatial zone controller can ascertain a signal strength with which they receive the terminal, whereupon the spatial zone controller can calculate an exact spatial position on the basis of the position reference list for the wireless access points by means of corresponding software algorithms. Furthermore, a position determination on the basis of a measurement of the signal propagation time from the terminal to individual access points from among the wireless access points (triangulation) or a measurement of the temporal difference in signal reception at these access points is also possible, in principle.

According to various aspects, however, the position can also be just the mere indication of the spatial zone as a whole, i.e. the event that the terminal has logged on at one of the wireless access points connected to the spatial zone controller. This aspect is relevant if a plurality of spatial zone controllers are provided and the entire spatial region is thereby subdivided into spatial zones which correspond to positions and permit information about whether the terminal is situated in a zone that is allowed or not allowed for it.

The spatial zone controller is connected to the wireless access points via a data line, e.g. Ethernet, DALI, KNX, etc., or wirelessly again via WLAN or Zigbee, etc. The spatial zone controller can be provided as an electronic component in a router, or in a decentralized manner e.g. in conjunction with one of the access points, or a wireless bridge or a wireless repeater. It can also be mapped purely at a software level and be implementable as a computer program in a computer-aided manner in a processor of e.g. a central or decentralized server.

Furthermore, provision is made of a central security controller, which is connected to the spatial zone controller and provides an access control list (ACL), wherein the access control list defines a network access restriction depending on device information and spatial positions. In this case, the network access restriction can include a simple access authorization or denial/rejection, or else offer a graded system with restricted access as well, for instance by providing access to a “dummy” radio network that transmits only for the terminal useless information such as, for example, advertising of the company operating the radio network.

The assignment of the network access restriction to a spatial position in the access control list is of importance. This allows the position of a logging-on terminal to be taken as an additional criterion as to whether or not the desired network access is justified for the specific terminal—identified by the device information such as, for example, its hardware or MAC address.

Specifically, as described in the introduction it is possible at a terminal to change the device address transmitted to the wireless access point and in this case to select and transmit e.g. that address of a terminal verified as not having access restriction after recording of communication. If the terminal with the device address is then situated at a position in an unauthorized region, for example outside a spatial region for which the terminal is authorized, in particular outside the building part in the rooms of a neighboring company, network access can be effectively prevented despite a falsified device address.

Conversely, by means of MAC filtering, a terminal with an unauthorized device address that is moving or situated (on the basis of the ascertained position) within the spatial region to be protected can be identified and prevented from gaining network access.

To that end, the spatial zone controller is designed to compare the received device information and the determined spatial position with the access control list in order to ascertain a corresponding network access restriction for the logging-on terminal and/or the external wireless access point, and, depending on the result, to prevent the logging-on terminal and/or the external wireless access point from gaining network access.

The at least one spatial zone controller and the central security controller can be connected to one another via wired or wireless communication, e.g. Ethernet, DALI, KNX, etc., or wirelessly again via WLAN or Zigbee, etc. Just like the spatial zone controller, the central security controller can be provided as an electronic component in a router, or in a decentralized manner, e.g. in conjunction with one of the access points, or a wireless bridge or a wireless repeater. Like said spatial zone controller, the central security controller can also be mapped purely at a software level, and be implementable as a computer program in a computer-aided manner in a processor of, for example, a central or decentralized server. The central security controller and the spatial zone controller can also be arranged or implemented as a program in the same device or in the same electronic component.

According to one particularly advantageous development, the wireless access points of the plurality are each assigned to a luminaire in the building or the physical structure and each have a common power supply therewith. In this case, it is advantageously possible to have recourse to the generally close-meshed network of luminaires such as are often present in office spaces or manufacturing halls, etc. Moreover, modern lighting installations offer central controllers and bus systems (such as DALI or KNX, or else wireless Zigbee) adapted thereto for controlling the individual luminaires of the lighting installation. Said bus systems are regularly narrowband since there are no stringent requirements made of the transmission rate because often only values for the setting parameters for the luminaires are communicated and/or sensor values are retrieved at time intervals.

In the case of this development, the spatial zone controller and/or else the central security server can be connected via such bus systems, i.e. connection of the spatial zone controller(s) to the wireless access points in the luminaires and connection of the spatial zone controllers to the central security controller. It has been found that for this requirement, too, the corresponding bus system of the lighting installation is completely sufficient (i.e. e.g. DALI, KNX or Zigbee), since there are only occasional requests of logging-on devices and corresponding security checks during the comparison with the access control list.

By contrast, the power supply can be effected via said bus system or over Ethernet (PoE, Power over Ethernet).

According to a further development, the plurality of wireless access points are arranged in a continuous, close-meshed, grid-like network, such that in the case of a terminal logging on in the network, on the basis of a temporally changing assignment to the wireless access points of the grid-like network, its position and movement in the building or the physical structure are continuously trackable. Such a close-meshed and primarily grid-like network affords the advantage that the resolution of the position determination is significantly increased.

Furthermore, in a grid (such as, for example, in the case of large-area lighting, in particular) position reference lists of the access points are simple to create; in particular, the individual positions of the access points are easy to detect during installation.

One particular advantage results here from the fact that the radiation power of the individual wireless access point can be significantly reduced since the neighboring access point is situated nearer in the close-meshed grid. Furthermore, if the invention is implemented in combination with luminaires as described above, characteristics of the luminaires such as reflectors, for example, can be used in order to achieve a directional effect of the WLAN radiation, such that the corresponding spatial zone in the close-meshed grid can be delimited to the desired spatial region, i.e. attacks from outside are avoided. The isotropic RF radiation power EIRP of the involved wireless access points in the plurality and in particular the subset for the spatial zone is, purely by way of example, 50 mW or at 2.4 GHz and 100 mW or less at 5 GHz.

According to a further development, the spatial zone controller is connected only to such wireless access points which are located in a spatial zone at an outer edge of the continuous, close-meshed, grid-like network. As a result, an inner spatial region can be shielded from unprotected or publically accessible regions outside the building or building part. Attacking terminals or external access points log on primarily at wireless access points of the protected spatial zone, wherein the spatial position of said terminals etc. can be ascertained by the corresponding spatial zone controller. The outer spatial zone then allows specific measures to be implemented with regard to the attackers, for example allows a dummy network to be set up which provides useless information for the attackers, or, using means to be described below, makes it more difficult or impossible to access the network of the inner spatial region.

According to a further development, a first and at least one second spatial zone are defined which correspond to different sections of the building, building part or physical structure and which are each assigned different, spatially continuously arranged subsets of the wireless access points in the building or the physical structure. A corresponding spatial zone controller is provided for each spatial zone. In this case, the central security controller is connected to all of the spatial zone controllers and provides the access control list to them. Terminals (clients) can be excluded by means of position determination in e.g. one of the zones for which entry is prohibited. If a user moves from the public spatial zone (“free zone”) into a zone for which entry is prohibited, the following, for example, could occur:
the user's terminal address (MAC address) is shifted from the whitelist to the blacklist;
the user's log-on in the network or a session can be disconnected from the wireless access point.

However, a deauthentication or alternatively a local reduction of the power (see below) may be used. An interaction between the spatial zones, i.e. communication between the respective spatial zone controllers (apart from the application of a central whitelist/blacklist), would thus be applicable in principle (i.e. an ascertained event in one spatial zone and defense measures implemented in the other). As a result, it becomes possible to realize different spatial security levels, e.g. public, only within the company and restricted to specialist responsibilities (development, accounts department, personnel, management, legal department).

According to a further development, the spatial zone controller(s) is/are designed to prevent the network access by causing at least one of the wireless access points assigned thereto to repeatedly transmit deauthentication frames with a specific hardware address of the terminal and/or external wireless access point, said hardware address being determined from the received device information. These methods, also called jamming, prevent the attacking terminal or the external access point from gaining network access particularly effectively and permanently. However, this aspect is expected not to be compatible with such wireless networks that conform to IEEE 802.11w.

According to a further development, the spatial zone controller(s) is/are designed to prevent the network access by ascertaining a specific hardware address of the terminal from the received device information and comparing it with a list of hardware addresses which are predefined either as released or alternatively as blocked in the access control list. As described, MAC filtering in combination with position determination is an effective means for detecting attackers.

According to a further development, the spatial zone controller(s) are designed to switch the connected wireless access points into a monitor mode in order to operate them as WLAN sniffers in order to detect the external wireless access points and to determine the spatial position thereof. As WLAN sniffers, the network access points of this spatial zone do not transmit any data. This development is therefore particularly advantageous in combination with a subset or spatial zone that is arranged in the edge region of the network and that shields the inner spatial region from a region outside the building part or building etc.

According to a further development, a notification device, which is connected to the security controller and/or the spatial zone controller and, in the case of the result of the comparison revealing an unauthorized network access by the terminal and/or the external access point, issues a warning message including the time of the unauthorized network access, the hardware address and the position of the terminal and/or of the external access point. As a result, it becomes possible to initiate further targeted measures or to create an attacker profile.

According to a further development, the spatial zone controller is designed to set a power with which the wireless access points communicate data packets individually for each wireless access point, wherein if, on account of the comparison with the access control list, the spatial zone controller establishes that the logging-on terminal or the external wireless access point is to be prevented from gaining network access, the spatial zone controller reduces or completely switches off the power of at least that wireless access point which corresponds to the detected position of the terminal or of the external wireless access point. This deprives the attacking terminal etc. of the possibility of obtaining data from the network, specifically precisely where it is located. The sniffing function can be maintained further in order to ascertain a position or to create a movement profile. The reduction or switching off of power carries on moving with the attacking terminal and, as a result, advantageously remains locally delimited—the attacker no longer sees a network. By analogy with the dynamic adaptation of power with which individual luminaires of a lighting installation are supplied in a targeted manner in order to supply sufficient light for a person moving through an otherwise dark space, this aspect can likewise be referred to as “swarming”.

According to a further development of this aspect, the spatial zone controller is designed additionally to individually reduce the power of those wireless access points which in the network are spatially adjacent to the wireless access point which corresponds to the detected position of the terminal or of the external wireless access point. With this augmentation, the reduction of power is locally adapted even better in order, on the one hand, to effectively prevent the attacker from gaining network access, but also, on the other hand, to minimize the effects on other terminals situated in the vicinity.

According to a corresponding development of this aspect, the subset of the wireless access points continues to be operated at least in the monitor mode even in the case where power is reduced or switched off by the spatial zone controller. The spatial zone controller, in the network, tracks the logged-on or logging-on terminal and/or the external wireless access point with regard to its position and movement through the first spatial zone on the basis of a temporally changing assignment to the wireless access points of the network, and the selection of that or those wireless access point(s) whose power is reduced for the data communication is updated on the basis of the tracked position.

According to a further development, the spatial zone controller is designed to set a power with which the wireless access points of the subset assigned to said controller communicate the data packets individually for each wireless access point, wherein the spatial zone controller operates the wireless access points with reduced or switched-off power for the communication of data packets during standard operation. If the spatial zone controller ascertains the spatial position of a terminal and/or of an external wireless access point and the comparison of the device information with the access control list reveals that the logging-on terminal is not to be prevented from gaining network access, the spatial zone controller increases the power of at least that wireless access point—and also of the wireless access points spatially adjacent thereto—which corresponds to the spatial position of the terminal and/or of an external wireless access point.

This aspect corresponds to a reversal of the previous aspect of “swarming”: here the entire network is operated with reduced radiation power and only selected wireless access points, in the region of which authorized terminals are situated, are increased with regard to their power. Aside from the energy saving and reduced radiation loading, network security is increased by virtue of the fact that network access for attackers per se as a whole is made more difficult by the network only ever being weakly visible or not visible at all to said attackers.

A method for providing a wireless network is also provided. It comprises the following steps:
providing a plurality of wireless access points, each of which provides access to the wireless network for a delimited spatial region in a building or in a physical structure,
providing a spatial zone controller which is connected to at least one portion of the wireless access points and is designed to receive, via the wireless access points connected to said controller, device information regarding a terminal logging on in the network and/or regarding an external wireless access point, and to determine the spatial position of the relevant terminal and/or external wireless access point in or close to the building or the physical structure on the basis of an assignment to one or more of the connected wireless access points, and
providing a central security controller, which is connected to the spatial zone controller and provides an access control list, wherein the access control list defines a network access restriction depending on device information and spatial positions,
wherein the spatial zone controller is designed to compare the received device information and the determined spatial position with the access control list in order to ascertain a corresponding network access restriction for the logging-on terminal and/or the external wireless access point, and, depending on the result, to prevent the logging-on terminal and/or the external wireless access point from gaining network access.

The same advantages arise as have been described with regard to the system and the developments thereof.

### BRIEF DESCRIPTION OF THE DRAWINGS

The accompanying drawings serve to provide an understanding of non-limiting embodiments. The drawings illustrate non-limiting embodiments and, together with the description, serve for explanation thereof. Further non-limiting embodiments and many of the intended advantages will become apparent directly from the following detailed description. The elements and structures shown in the drawings are not necessarily shown to scale relative to each other. Like reference numerals refer to like or corresponding elements and structures.

FIG. 1 shows in a schematic illustration a plan view of a floor plan of a floor of a building with an arrangement of luminaires and wireless access points in the center of the arrangement in a system in accordance with the prior art;

FIG. 2 shows in a schematic illustration a plan view of a floor plan of a floor of a building with an arrangement of luminaires and wireless access points respectively assigned thereto in spatial zones of a system for establishing a wireless network in accordance with a first exemplary embodiment;

FIG. 3 as FIG. 2, but in accordance with a modification of the exemplary embodiment;

FIG. 4 shows a block diagram with an overview of the system in accordance with the first exemplary embodiment;

FIG. 5 shows a flow diagram for elucidating the functioning of the system from FIG. 4; and

FIG. 6 shows a schematic diagram for elucidating the jamming used in the first and second exemplary embodiments;

FIG. 7 shows in a schematic illustration a plan view of a floor plan of a floor of a building with an arrangement of luminaires and wireless access points respectively assigned thereto in spatial zones of a system for establishing a wireless network in accordance with a second embodiment.

### DETAILED DESCRIPTION

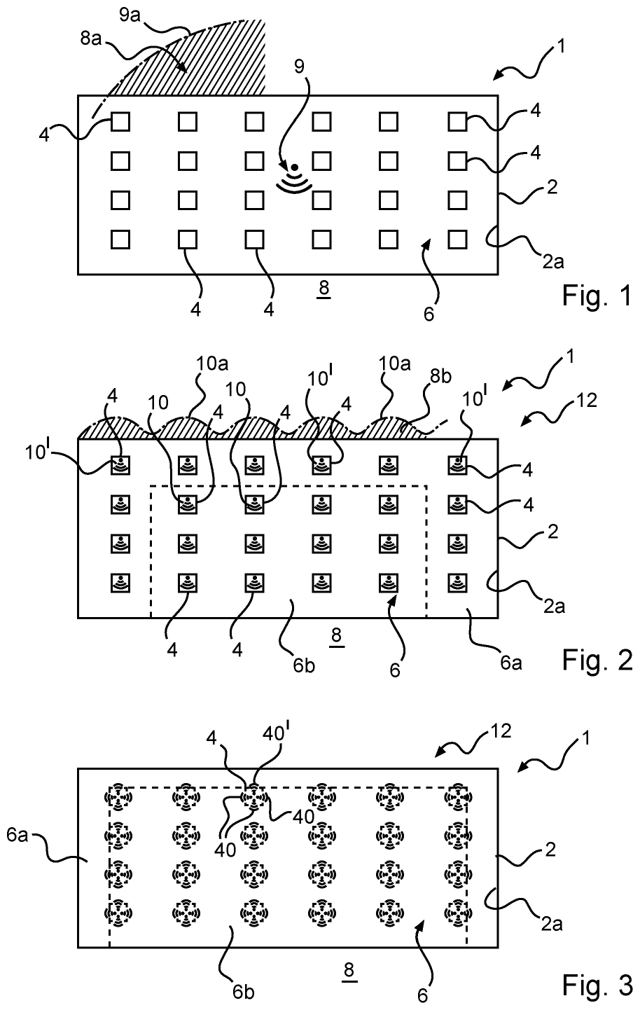

A conventional system for establishing a radio network is depicted schematically in FIG. 1 as a comparative example with respect to the invention. The schematic illustration reveals in plan view the floor plan of a floor of a building or building part 1 delimited by outer walls 2. The interior 6 of the building is provided with a ceiling lighting arrangement consisting of a matrix or grid of luminaires 4, which are thus arranged e.g. in rows and columns with respectively suitable spacings among one another in order to achieve as homogenous an illumination as possible of the depicted space 2a in the floor of the building or building part 1. Each luminaire 4 can be assigned directly to one or more work areas (not shown) situated underneath. By way of example, this can be an open-plan office.

A wireless or radio network can be established in the building or building part 1 by means of a respective wireless access point 9 (AP) for each floor. It is also possible for just one access point 9 in total to be provided. The access point 9 can be connected to a router, such that access to a network in the Internet can be established by means of a bridge and a switch (not shown). Switch, bridge, router and access point 9 can be set up in one and the same device.

The power of the radiation emitted in the space 2a is designed so that even such terminals (clients) which are situated for example in the corners of the space 2a, e.g. under the luminaire 4 at the top left in FIG. 1, obtain a sufficient radiation intensity in order to be able to establish a stable connection to the wireless access point 9. If the wireless access point 9, like the luminaires 4, for example, radiates from the ceiling largely isotropically at least into the plane of the floor, then it follows from this that—as is indicated in FIG. 1 by the dash-dotted line representing a range 9a of the wireless access point 9—also in a region 8 outside the building or building part 1, namely in the region 8a identified by hatching, it is possible for any terminals situated there to be provided with network access, assuming that the outer walls are substantially transmissive to the radiofrequency radiation. By virtue of the here just one wireless access point 9 (e.g. for each floor, space or open-plan office) and also the geometry of the floor plan, this region 8a here is particularly large.

A first exemplary embodiment of a system for establishing a wireless network, here a WLAN or Wi-Fi network conforming to IEEE 802.11, which can eliminate this disadvantage, is illustrated in FIG. 2. The conditions of the building or building part 1 with outer walls 2 and space 2a therein shall be identical to the comparative example in FIG. 1. Here each luminaire 4 in the space 2a is respectively assigned a wireless access point 10 or 10′. The luminaires are controlled centrally by a control device e.g. by means of a communication system known from building automation. Each wireless access point 10, 10′ can be installed integrally with the luminaire (e.g. in the ceiling of the space) by virtue of the fact that said wireless access point has recourse e.g. to the frame or reflector of said luminaire for its antenna function and/or recourse to a common controller and/or cabling connection/data link (Ethernet, DALI, KNX etc.). One advantage is that where light is required for work areas, then there is regularly also a need for a network connection. In this exemplary embodiment, the radiation power for the plurality of wireless access points 10, 10′ can be embodied as significantly lower, e.g. can be significantly below the maximum permissible radiation power, for instance 50 mW or less for 2.4 GHz and/or 100 mW or less for 5 GHz frequency intervals. By way of example, the ranges of light and RF radiation can be adapted to one another.

The assignment of the wireless access points 10, 10′ to the luminaires 4 gives rise to a spatially grid-like and close-meshed network arrangement 12 with a high position resolution.

As can be seen schematically in FIG. 2, the hatched region 8b in a region 8 outside the interior 6 of the building or building part 1 in which network access is still possible is significantly reduced in comparison to the situation in FIG. 1, and so the security of the radio network is also improved.

In this first exemplary embodiment, the wireless access points 10′ located spatially at the edge of the network arrangement 12 form a first spatial zone 6a, while those not located at the edge form a second spatial zone 6b. The spatial zones 6a, 6b denote that space which is covered by radiation and reception for network access by the respective wireless access points 10, 10′ which are logically assigned to the relevant spatial zone 6a, 6b. The spatial zones 6a, 6b are each per se continuous spatial regions.

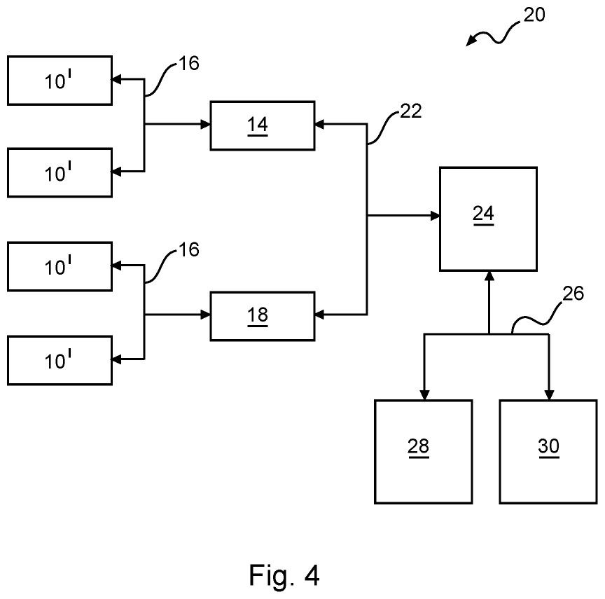

The wireless access points 10′ of the first spatial zone 6a are connected to a first spatial zone controller 14 (referred to as: area controller) via a data line 16, as can be seen in FIG. 4, which shows the set-up of the system 20. The data line 16, if wired, can involve Ethernet, or a DALI bus (DALI, in accordance with the IEC 62386 family of standards, DALI stands for “Digital Addressable Lighting Interface”), KNX bus, or, if not wired, can involve Zigbee or else WLAN itself, etc.

Likewise, the wireless access points 10 of the second spatial zone 6b are connected to a second spatial zone controller 18 (area controller) via a corresponding data line 16.

In this case, the first spatial zone controller 14 is designed to control individual or a plurality of the wireless access points 10′ connected to it such that one or more of the below-described defense measures against potential attackers are brought to bear, which in particular concern terminals situated in the outside region 8 if they want to obtain access to the internal network via one of the wireless access points 10′ (for example by means of network logging on).

A first measure consists in identifying the relevant terminal and rejecting it in the case where authorization is lacking. Firstly, for this purpose it is necessary to determine specific device information such as, for instance, the inherently unique MAC address (Media Access Control address) as a hardware address of the relevant terminal and to compare it later with an access control list. In the case of Ethernet, the MAC address comprises a total of 48 bits or 6 bytes, which are often present in hexadecimal notation and are written byte by byte in a manner separated by colons. The first spatial zone controller 14 receives these data from the corresponding wireless access point 10′ when the terminal establishes contact/logs on via the data line 16.

In this respect, FIG. 4 furthermore shows a security controller 24 connected to the first spatial zone controller 14 and also the second spatial zone controller 18 via a data line 22. Said security controller centrally keeps available the access control list. The access control list comprises a so-called “whitelist” with all terminals, or the MAC addresses thereof, which are to be granted access to the network, and/or a so-called “blacklist” with all such terminals, or the MAC addresses thereof, which are to be expressly denied access to the network. Such access control lists can be stored in a table in a file or in a database.

As is illustrated in FIG. 4, the security controller 24 is furthermore connected via a data line 26 to an administration interface 28, for example a web interface or a terminal or computer with secure-shell (SSH) access to the corresponding configuration file in order to configure and maintain the access control list. Furthermore, the security controller 24 is also connected to an external notification device 30, which issues warning messages to the user or network operator, for example, in the event of attacks by unauthorized terminals etc. having been established.

The first spatial zone controller 14 compares the received MAC address with the list of valid MAC addresses (whitelist) or invalid MAC addresses (blacklist) in the access control list. This can be effected in the form of a request to the security controller 24 that involves the first spatial zone controller sending the MAC address and receiving from the security controller 24, or the database or table forming or managed by said security controller, feedback as to whether or not a hit is present, or by virtue of said spatial zone controller in each case currently or regularly loading and itself individually comparing the complete access control list.

If the first spatial zone controller 14 establishes that there is a violation, it prevents access for the relevant terminal by means of a rejection.

A further or alternative measure consists in causing at least one of the wireless access points assigned to the spatial zone controller 14 to repeatedly transmit deauthentication frames with the MAC address of the terminal determined from the received device information. This is referred to as jamming. The terminal is thereby repeatedly caused to end the network access automatically of its own accord. Therefore, an effective permanent network access never occurs.

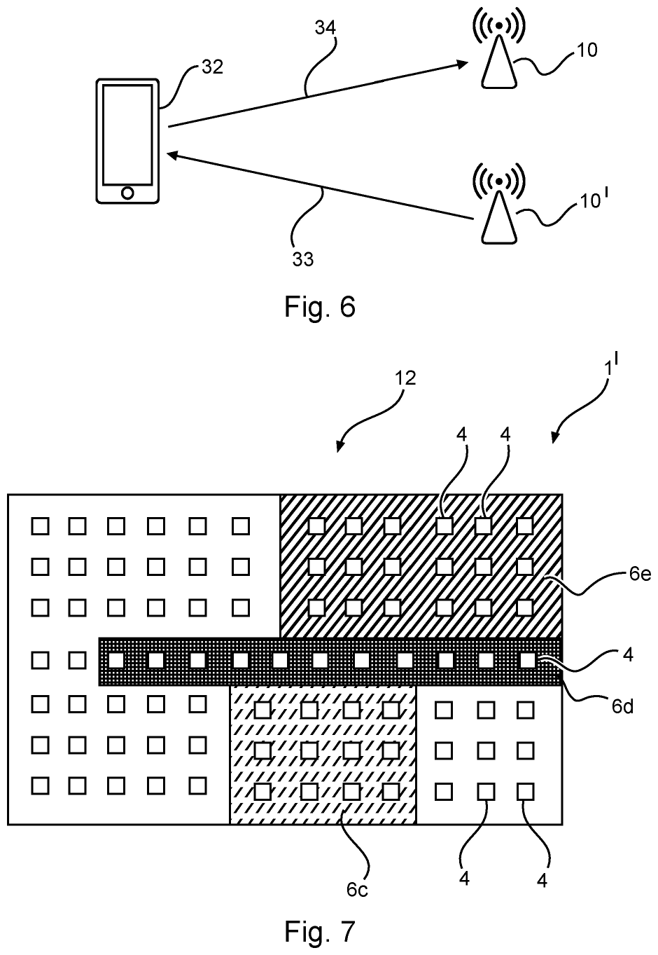

The situation is illustrated in a modified exemplary embodiment in FIG. 6. In this case, as described, one of the wireless access points 10′ of the spatial zone 6a repeatedly sends deauthentication frames to the terminal 32 (illustrated as a smartphone here purely schematically). However, said deauthentication frames are such that the terminal 32 logs off from another wireless access point 10, specifically in the inner spatial zone 6b, or repeatedly ends its connection thereto.

Since it is possible, as described in the introduction, for the MAC address communicated by the terminal to be changed by the operating system or at the software level, in particular to a MAC address deemed to be authorized by the network, which can be established for third parties by sniffing in this exemplary embodiment even further measures are taken for checking the authorization of the terminal.

In this case, the spatial zone controller 14 is designed to assign a position to the logging-on terminal or to determine said position. The position can be the spatial zone 6a itself, or the position of that wireless access point 10′ at which the terminal attempts to log on. Furthermore, an accurate position determination can be effected by a procedure in which, for a plurality of wireless access points, the power of the received signal is detected and compared with one another in regard to the position of the wireless access points 10′ themselves. In FIG. 2, this all leads to a localization in the spatial zone 6a near the outer wall 2 and, if appropriate, to a differentiation as to whether in the interior 6 of the space 2a or in the outside region 8. This additional information allows the first spatial zone controller 14 to carry out an assessment on the basis of the logging on of the terminal 32. For this purpose, the access control list furthermore contains information to the effect of whether the terminal assigned to the MAC address is authorized to be situated at this position (i.e. in this spatial zone, or at this wireless access point, or at this exact location). In this case, the first spatial zone controller 14 compares the position (i.e. spatial zone, region of the wireless access point, or more precisely location) stored in the access control list for this MAC address with the position actually assigned, and implements one of the abovementioned measures as a result of this.

If the MAC address is neither in a whitelist nor in a blacklist, a default can be provided (e.g. access for all addresses not in blacklist, rejection etc. for all addresses not in whitelist, etc.).

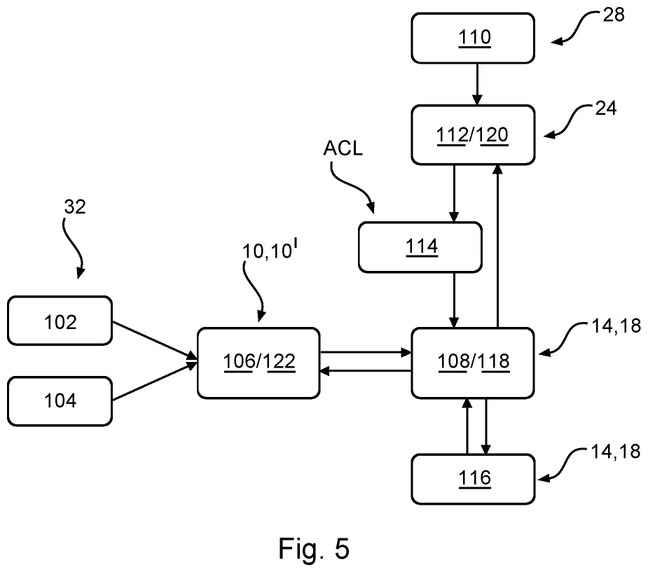

FIG. 5 shows in a flow diagram an overview of the sequence of the method: in a step 102, an (e.g. unauthorized) terminal 32 logs on in the wireless network, or alternatively, in step 104, an external wireless access point that is not part of the radio network logs on as terminal 32 (e.g. man-in-the-middle attack).

In step 106, the wireless access point 10′ receives the device information and forwards it to the first spatial zone controller 14.

In step 108, the first spatial zone controller 14 receives the device information and compares it with a distributed access control list (ACL), which has likewise been communicated to and received by said spatial zone controller.

For this purpose, beforehand in a step 110, the access control list is configured by way of a web interface (administration interface 28) and a whitelist with the terminals 32 authorized for network access is created in the process, the whitelist being related to spatial zones, i.e. containing network access restrictions in regard to positions of the terminals. In a step 112, said access control list is saved and stored in a table or database in the central security controller 24. In a step 14, said access control list is distributed (communicated) to the spatial zone controllers 14, 18, inter alia to the first spatial zone controller 14.

In a step 116, the first spatial zone controller 14 calculates the position of the terminal 32 as described above, on the basis of the communicated information from the connected wireless access point(s) 10′, and, in step 118, the first spatial zone controller 14 compares the ascertained, determined or calculated position with the position saved in the access control list (or derivable from the latter) for network access or rejection for the MAC address. In the case where the comparison leads to a rejection, in step 120 the central security controller 24 is caused to issue a warning in the notification device 30.

Furthermore, in this specific exemplary embodiment, in step 122, the wireless access point 10′ is caused to transmit a deauthentication frame, such that the terminal logs off from e.g. another wireless access point 10 (i.e. ends the connection).

It should be noted that the wireless access points 10′ of the first exemplary embodiment can particularly advantageously also be operated in the monitor mode, that is to say that they are themselves operated as it were as sniffers.

A modification of said first exemplary embodiment will be described with reference to FIG. 3. The grid-like, close-meshed network 12 of wireless access points is additionally refined here by each luminaire 4 being assigned e.g. four wireless access points with in each case differently oriented antennas. Here only the wireless access points 40′ facing the outside region 8 at the edge of the network 12 are assigned to the first spatial zone 6a, while the wireless access points 40 facing inward or other, neighboring access points, even also in luminaires 4 near the outer wall 2, are assigned to the second inner spatial zone 6b. As a result, the spatial zone 6a becomes smaller, such that, if its wireless access points 40′ are operated in the monitor mode, for example, more space is available for the actual network.

A second exemplary embodiment will be described with reference to FIG. 7. In this exemplary embodiment, there are no longer only two spatial zones defined, but rather three spatial zones: a public spatial zone 6c, a spatial zone 6d with restricted network access, and a spatial zone 6e without network access. They are e.g. a region for customers, a corridor or intermediate section and a security space in a building 1 in this order. In FIG. 7, for the sake of clarity, only the luminaires 4 are shown, the wireless access points not being shown any more. However, the assignment of wireless access points to luminaires here is as in FIG. 2 or 3.

The corresponding system 1′ is configured as shown in FIGS. 4 and 5. In this exemplary embodiment, an access control list ACL is configured in the case of which a spatial zone controller (not shown) for the spatial zone 6c carries e.g. neither a blacklist nor a whitelist. Position information implicitly relates to the entire spatial zone for all possible MAC addresses (the entire spatial zone allows all positions in the spatial zone).

For the more security-relevant spatial zone 6d a whitelist exists, for example. The corresponding position information implicitly relates to the entire spatial zone for all MAC addresses of the whitelist. For all other possible MAC addresses, the position, i.e. the entire spatial zone with all wireless access points contained, is invalid and results in a warning message.

In the absolute security zone, i.e. spatial zone 6e, no terminal at all is authorized. The position information again implicitly relates to the entire spatial zone 6e, now for all possible MAC addresses.

In this embodiment of graded authorizations for network accesses, swarming methods as described above can advantageously be used as well. In this case, a power with which the wireless access points communicate data packets is set individually for each wireless access point. If, owing to the comparison with the access control list, the spatial zone controller establishes that the logging-on terminal 32 is to be prevented from gaining network access, the corresponding spatial zone controller reduces only locally the power of that or those wireless access point(s) corresponding to the detected position of the terminal or of the external wireless access point. By means of sniffing, moreover, a position determination can be maintained in order to create a movement profile. The reduction or switching off of power carries on moving with the unauthorized terminal and, as a result, advantageously remains locally delimited—the attacker no longer sees a network. By analogy with the dynamic adaptation of power with which individual luminaires of a lighting installation are supplied in a targeted manner in order to supply sufficient light for a person moving through an otherwise dark space, this aspect can likewise be referred to as “swarming”.

Thus, the movement of a terminal through the network of access points and, if appropriate, through the spatial zones, can also be recorded (tracking). It is even possible for measures to be taken depending on the movement profile. If a terminal moves from wireless access point to wireless access point at the outer edge of a spatial zone, for example, then the profile can be used as a basis for estimating a probability that the terminal is possibly moving at a wall outside the actual spatial region and is therefore not authorized. Corresponding measures can then likewise be taken here.

It should be noted that the exemplary embodiments described above constitute specific embodiments and do not delimit the scope of protection defined by the appended claims. In particular, individual features of the individual exemplary embodiments can also be combined into respective other exemplary embodiments. By way of example, defense measures such as MAC filtering, jamming (transmission of deauthentication signals), swarming, can also be implemented in combination or alternatively only on a case by case basis—depending on the seriousness or type of the attack.

In this application, the expression “logging on” by the terminal can be understood as a registration process with a definition of the transmission parameters between terminal and access point. However, “log on” is also understood here as just the mere transmission of data packets by way of the terminal, which are effected in response to beacons by way of the access point, i.e. mere contact-making. Likewise, “logging off” includes mere ending of the connection.

In the exemplary embodiments, the spatial zone controllers 14, 18 and the security controller 24 have been described as being connected via a data line 22, which might imply a physical constitution as separate electronic components. It goes without saying, however, that the controllers can also be constituted just as separate computer-implemented programs that run on separate computers, servers or local nodes or alternatively on the same computer, server or local node.

### LIST OF REFERENCE SIGNS

1, 1′ Building, building part, physical structure
2, 2a Outer wall, space, spatial region
4 Luminaires
6 Interior (building)
6a-e Spatial zones
8 Outside region (building)
9 Wireless access point (conventional)
9a Range
10, 10′ Wireless access points
10a Range
12 Network-like arrangement of wireless access points
14 Spatial zone controller
16 Data line
18 Spatial zone controller
20 System for establishing a wireless network
22 Data line
24 Spatial zone controller
26 Data line
28 Administration interface
30 Notification device
32 Terminal
33 Transmission of deauthentication frames
34 Ending of the connection
40, 40′ Wireless access points (directional antenna)
102 Logging on of a terminal
104 Logging on of an external wireless access point
106 Reception of the MAC address and forwarding (AP)
108 Reception of the MAC address by spatial zone controller
110 Configuring access control list (ACL)
112 Storing access control list (ACL)
114 Distributing ACL to spatial zone controller
116 Calculating the position
118 Comparing MAC address and position with ACL
120 Warning message: system violation
ACL Access control list

1. A system for providing a wireless network, wherein the system comprises:
a plurality of wireless access points, each of which provides access to the wireless network for a delimited spatial region in a building or in a physical structure;
at least one spatial zone controller connected to at least one portion of the wireless access points and is configured to receive, via the wireless access points connected to said controller, device information regarding a terminal logging on in the network and/or regarding an external wireless access point, and to determine the spatial position of the relevant terminal and/or external wireless access point in or close to the building or the physical structure on the basis of an assignment to one or more of the connected wireless access points; and
a central security controller connected to the spatial zone controller and provides an access control list, wherein the access control list defines a network access restriction depending on device information and spatial positions;
wherein the spatial zone controller is configured to compare the received device information and the determined spatial position with the access control list in order to ascertain a corresponding network access restriction for the logging-on terminal and/or the external wireless access point, and, depending on the result, to prevent the logging-on terminal and/or the external wireless access point from gaining network access.

2. The system as claimed in claim 1, wherein
each wireless access point of the plurality wireless access points is assigned to a luminaire in the building or the physical structure and each have a common power supply therewith.

3. The system as claimed in claim 1, wherein
the plurality of wireless access points is arranged in a continuous, close-meshed, grid-like network, such that in the case of a terminal logging on in the network, on the basis of a temporally changing assignment to the wireless access points of the grid-like network, its position and movement in the building or the physical structure are continuously trackable.

4. The system as claimed in claim 3, wherein
the spatial zone controller is connected only to such wireless access points located in a spatial zone at an outer edge of the continuous, close-meshed, grid-like network.

5. The system as claimed in claim 3, wherein
a first and at least one second spatial zone are defined corresponding to different sections of the building or physical structure and which are each assigned different, spatially continuously arranged subsets of the wireless access points in the building or the physical structure,
wherein a corresponding spatial zone controller is provided for each spatial zone, and
wherein the central security controller is connected to all of the spatial zone controllers and provides the access control list to them.

6. The system as claimed in claim 1, wherein
the spatial zone controller(s) is/are configured to prevent the network access by causing at least one of the wireless access points assigned thereto to repeatedly transmit deauthentication frames with a specific hardware address of the terminal and/or external wireless access point, said hardware address being determined from the received device information.

7. The system as claimed in claim 1, wherein
the spatial zone controller(s) is/are configured to prevent the network access by ascertaining a specific hardware address of the terminal from the received device information and comparing it with a list of hardware addresses predefined either as released or alternatively as blocked in the access control list.

8. The system as claimed in claim 1, wherein
the spatial zone controller(s) is/are configured to switch the connected wireless access points into a monitor mode in order to operate them as WLAN sniffers in order to detect the external wireless access points and to determine the spatial position thereof.

9. The system as claimed in claim 1, further comprising
a notification device connected to the security controller and/or the spatial zone controller and, in the case of the result of the comparison revealing an unauthorized network access by the terminal and/or the external access point, issues a warning message including the time of the unauthorized network access, the hardware address and the position of the terminal and/or of the external access point.

10. The system as claimed in claim 1, wherein
the spatial zone controller is configured to set a power with which the wireless access points communicate data packets individually for each wireless access point,
wherein if, on account of the comparison with the access control list, the spatial zone controller establishes that the logged-on or logging-on terminal or the external wireless access point is to be prevented from gaining network access, the spatial zone controller reduces or completely switches off the power of at least that wireless access point corresponding to the detected position of the terminal or of the external wireless access point.

11. The system as claimed in claim 10, wherein
the spatial zone controller is configured additionally further configured to individually reduce the power of those wireless access points which in the network are spatially adjacent to the wireless access point corresponding to the detected position of the terminal or of the external wireless access point.

12. The system as claimed in claim 10, wherein
the subset of the wireless access points continues to be operated at least in the monitor mode even in the case where power is reduced or switched off by the spatial zone controller;
the spatial zone controller, in the network, tracks the logged-on or logging-on terminal and/or the external wireless access point with regard to its position and movement through the first spatial zone on the basis of a temporally changing assignment to the wireless access points of the network; and
the selection of that or those wireless access point(s) whose power is reduced for the data communication is updated on the basis of the tracked position.

13. The system as claimed in claim 1, wherein
the spatial zone controller is configured to set a power with which the wireless access points of the subset assigned to said controller communicate the data packets individually for each wireless access point;
wherein the spatial zone controller operates the wireless access points with reduced or switched-off power for the communication of data packets during standard operation;
wherein if the spatial zone controller ascertains the spatial position of a terminal and/or of an external wireless access point and the comparison of the device information with the access control list reveals that the logged-on or logging-on terminal or the external access point is not to be prevented from gaining network access, the spatial zone controller increases the power of at least that wireless access point corresponding to the spatial position of the terminal and/or of an external wireless access point.

14. A method for providing a wireless network, wherein the method comprises:
providing a plurality of wireless access points, each of which provides access to the wireless network for a delimited spatial region in a building or in a physical structure;
providing a spatial zone controller which is connected to at least one portion of the wireless access points and is configured to receive, via the wireless access points connected to said controller, device information regarding a terminal logging on in the network and/or regarding an external wireless access point, and to determine the spatial position of the relevant terminal and/or external wireless access point in or close to the building or the physical structure on the basis of an assignment to one or more of the connected wireless access points; and
providing a central security controller connected to the spatial zone controller and provides an access control list, wherein the access control list defines a network access restriction depending on device information and spatial positions;
wherein the spatial zone controller is configured to compare the received device information and the determined spatial position with the access control list in order to ascertain a corresponding network access restriction for the logging-on terminal and/or the external wireless access point, and, depending on the result, to prevent the logging-on terminal and/or the external wireless access point from gaining network access.
